(19) United States
(12) Patent Application Publication
(10) Pub. No.: US 2002/0101728 A1
(43) Pub. Date: Aug. 1, 2002

(54) Nighttime drive safety warning structure

(76) Inventor: Chien Chang Huang, Taoyuan Hsien (TW)

Correspondence Address: Keith kline, PRO-TECHTOR INTERNATIONAL SERVICES, 20775 Norada Court, Saratoga, CA, 95070-3018, US

(21) Appl. No.: 09/774,741

(22) Filed: Jan. 30, 2001

(51) Int. Cl. F21K 2/00; F21V 9/16; G08B 5/36

(52) U.S. Cl. 362/84; 362/145; 362/540; 340/815.4

(57) ABSTRACT

A warning structure applied on transportation means and traffic facilities to improve nighttime drive safety essentially by applying an illuminating, primary course on the exposed mechanical parts such as a rim or a license plate on the transportation means or mark lines on roadway, then a finishing course of friction resistant coating is applied over and to protect the primary course, within, said illuminating course absorbs photo energy emitted from the sun and lights, then release such energy in visible light particularly during nighttime or rainy day to improve the visibility for the driver.

### BACKGROUND OF THE INVENTION

(a) Field of the Invention

The present invention relates to a night drive safety warning structure applied on transportation means and traffic facilities, and more particularly, to one that incorporates an illuminating material to release light at night or in road condition with poor visibility such as in rainy day to improve drive safety.

(b) Description of the Prior Art

Poor visibility onroad significantly contributes to many car accidents. Drivers are required to be very carefully when passing a road section lacking in lighting facilities or presenting poor visibility at night or in rainy day to avoid car accident.

To cope with poor visibility, mass reflective boards are used on transportation means and traffic facilities to reflect any light from any source received by the boards to warn the driver. However, the reflective board functions only when it is subject to external light source, and its function is also limited to a certain angle of reflection. For a reflective board or panel mounted on body of the transportation means, many drivers tend to forget or fail to turn on the headlight immediately upon entering a tunnel or other darker road sections during broad daylight. Their safety is seriously endangered due to poor visibility since the reflective board (panel) does not function at all particularly when the road section is not provided with lighting facilities or not operating if provided. On the other hand, the reflective board provided on road mark lines is vulnerable to deterioration, breakage or damage for being constantly rolled over by the passing vehicles. Therefore, a heavy, frequent or periodical road maintenance and replacement is required. Furthermore, such road service work requires to close a certain section or road resulting in traffic jamming since the traffic flow is affected.

### SUMMARY OF THE INVENTION

The primary purpose of the present invention is to provide a nighttime warning structure that can be applied on the transportation means and the traffic facilities to emit sufficient light for vehicles passing through road section with poor visibility to ensure of drive safety.

To achieve the purpose, the present invention discloses a structure incorporating an illuminating material to improve drive safety. The illuminating material relates to one that is capable of absorbing and storing photo energy from solar source or other lighting facilities. Such a process is referred to as excitement. Upon the excitement stops, the photo energy absorbed is then released in visible form for a comparatively long period. In the present invention, said illuminating material is essentially applied on certain external mechanical parts, namely, a rim or license plate, of the transportation means, or on the surface of road mark lines to form an illuminating course combined with other necessary materials. Furthermore, a finishing course of friction resistant coating is applied over the illuminating material. By taking advantage of the features of the illuminating material to absorb photo energy from the solar and other lighting sources, then to release said energy in visible form during nighttime or in rainy day, the present invention achieves its warning effect to improve drive safety.

The illuminating material used in the present invention relates to one that provides more than ten (10) hours of illuminating capability without relying on any other energy source after the excitement terminates. In addition, said illuminating material for not containing any radioactive elements will not cause any environmental problems.

### BRIEF DESCRIPTION OF THE DRAWINGS

FIG. 1 is a side view of a preferred embodiment of the present invention.

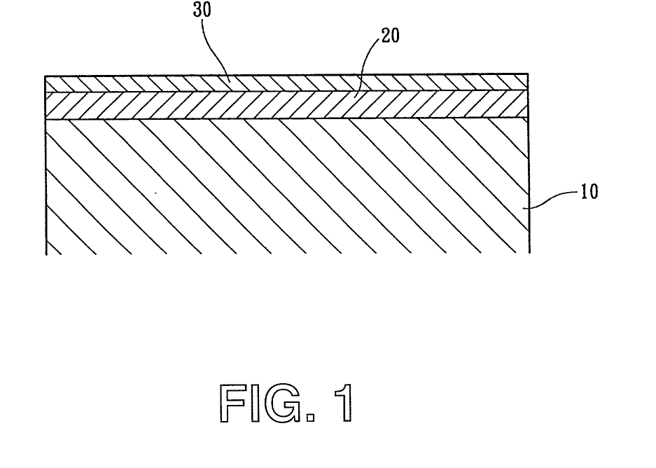

### DETAILED DESCRIPTION OF THE PREFERRED EMBODIMENTS

The present invention relates to a night drive safety warning structure to be applied on transportation means and traffic facilities. It is essentially comprised of an illuminating course 20 applied on an external mechanical part 10 or on the surface of a road mark line, and a friction resistant coating 30 applied over the illuminating course 20. Wherein, the illuminating course is a product of crystallization from aggregates of Al₂O₃, ScCO₃, HBO₃ and EU in given mixing ratio. The crystallization features persistent illumination effects and does not contain any radioactive substance. The friction resistant coating 30 refers to a transparent silicon sealant or any other materials that can form a film to protect the illuminating course 20.

The illuminating course 20 features that

(1) It creates no threaten to human health since its total α specific activity, total β specific activity and total γ activity are all smaller than that of the soil and food products.

(2) It gives persistent illuminating effect. Once excited during daytime, it illuminates at night for more than ten (10) hours. That is, when it is excited during daytime by the sun, its illuminating effect could last over night until the next morning.

(3) It gives high illumination. Its initial illumination (within thirty seconds up to one minute after excitement terminates) could reach several folds of that from phosphorous material.

(4) It gives good thermal stability. Its illuminating effect is not affected even at a temperature as high as 500° C. In addition, the lower the temperature is, the better illuminating effect is provided.

Therefore, once applied on transportation means and traffic facilities, the present invention gives highly visible and persistent illumination to give highly efficient warning effect. If the illuminating course 20 is applied on a rim or a license plate of a vehicle, the location of the vehicle is easily and precisely identical to all other drivers nearby. If the illuminating course 20 is applied on a traffic mark line or other road signs, drivers can easily read the road conditions and the contents of the signs to improve drive safety.

In comparison to the prior art of reflective boards, the illuminating course 20 of the present invention gives better warning effect as its illumination is self-provided. The illuminating course 20 disclosed in the present invention refers to a preferred embodiment of the present invention and it does not limit the scope of application of the present invention. For example,

(1) Resin, ink, fiber or coating can be added into the illumination course 20 to form various types of illuminating coatings and fibers. Therefore, the present invention can be used as a weak light source at night without depending on any other forms of light source or it can be used for decoration purpose challenging human imagination. The mixing ratio can be adjusted depending on its end purpose. It is recommended at 10˜30% in case of adding the resin; 50˜100%, the ink and 30%, the coating by weight. In general, the higher mixing ratio and the thicker film is, the better effect is given.

(2) Location Identification. The illuminating course 20 may be applied on electric switches, locks, keys, and fire fighting gears for easy identification of their location.

(3) Power-saving. The illuminating course 20 may be applied on stairs, corridors and seat numbers in a cinema house for power saving purpose.

(4) The illuminating course 20 when applied in remote area where no city power could reach or in area with higher power demands helps store the solar energy for night consumption.

(5) Decoration. When the illuminating course 20 is applied in a dancing hall, fashion occasion or AD boards, it gives a unique decorative effect.

(6) Timers. When the illuminating course 20 is applied on the surface of a timer, it tells time visibly during nighttime.

Any modification and finishing may be given to the scope of claims of the present invention shall be therefore covered by said claims.

I claim

1. A nighttime drive safety warning structure on transportation means and traffic facilities essentially comprised of an illuminating course applied on exposed mechanical parts of the transportation means or roadmark lines, and a friction resistant course applied over the illuminating course; within, said illuminating course absorbs photo energy emitted from the sun or other lighting sources during day time and release the photo energy in visible form during night or where poor visibility presents to improve drive visibility.

2. A nighttime drive safety warning structure on transportation means and traffic facilities as claimed in claim 1, within, said illuminating course is essentially a crystallization of Al₂O₃, ScCO₃, HBO₃ and EU in given mixing ratio.

3. A nighttime drive safety warning structure on transportation means and traffic facilities as claimed in claim 1, within, resin, ink, fiber or any coating is added into the illuminating course.

4. A nighttime drive safety warning structure on transportation means and traffic facilities as claimed in claim 1, within, said friction resistant coating relates to transparent silicon sealant.
